(19) United States
(12) Patent Application Publication
(10) Pub. No.: US 2006/0196559 A1
(43) Pub. Date: Sep. 7, 2006

(54) Valve pressure accumulator

(76) Inventor: David L. Baker, Kingsbury, TX (US)

Correspondence Address: David P. LeCroy;Patent Office of David P. LeCroy, Post Office Box 631, Manville, NJ, 08835-0631, US

(21) Appl. No.: 11/073,558

(22) Filed: Mar. 7, 2005

(51) Int. Cl. F16K 47/02

(52) U.S. Cl. 137/560

(57) ABSTRACT

A pressure accumulator for valves. The pressure accumulator enables pressure to be limited in a water hydrant due to the freezing of the fluid within the valve chamber. The accumulator includes a polymeric material that is able to compress as pressure within the valve increases. The accumulator can further include an external pressure stem surrounding at least a portion of the length of a valve stem of the valve.

### BACKGROUND OF THE INVENTION

1. Field of the Invention

The present invention relates to an improvement in water hydrants designed to prevent the hydrant valve from bursting in freezing conditions. More specifically, the present invention relates to a pressure accumulator within the hydrant that enables pressure to be reduced below rupture pressure throughout the water hydrant. This is accomplished by ‘absorbing’ the growth of water within the hydrant due to the water freezing. The absorption capacity available is augmented by displacement of at least part of the original volume within the hydrant, thereby reducing the potential amount of frozen water pressure growth.

2. Background Information

Damage often occurs to water pipes and faucets that are externally exposed to freezing conditions due to the expansion of water when it freezes. As a solution to this problem, hydrants or faucets have been designed that are mounted within the wall of a building, such as is described in U.S. Pat. No. 4,022,243. This placement of the hydrant is typically warm enough to prevent freezing of the piping, although the faucet head that is exposed to the elements can still be subject to freezing. Water found in the hydrant supply piping in the wall can be kept above freezing simply from the heat of the building that it is placed in. But the piping that forms the body of the hydrant communicates with the outside weather and can freeze if the weather is cold enough. Further, this valve piping is typically placed in the wall at a slight angle so that water is directed towards the faucet head. In doing so, water within the valve body of the hydrant is able to discharge from the body prior to a freezing situation.

Still, this design is not foolproof in preventing any water within the wall hydrant from freezing during inclement conditions. For example, a hose may be connected to the faucet head. This hose can be in a position where it is at an elevation higher than the wall hydrant, such as mounted on a reel above the hydrant. Further, the hydrant may be installed improperly with the discharge end not lower than the supply end. Also, the building may settle so that the discharge end is not lower than the supply end.

FIG. 1 is an exploded view of a commercially available sill cock or wall hydrant with the hydrant generally designated as numeral 10. Referring to FIG. 1, it is seen that the hydrant includes a handle 14, a faucet head 13 and a valve body or housing 15. The valve housing 15 can be of any material suitable for use in wall hydrant applications, such as copper, stainless steel, polyvinyl chloride, etc. Typically, the housing 15 is copper tubing. The housing 15 can be of any length through the wall required to connect the externally mounted head 13 with an internal fluid supply line (not shown).

At the supply end 11 of the housing 15 is mounted a valve body connector or adapter 16 for connecting the wall hydrant 10 with the water supply. At least part of the adapter 16 can be threaded for connecting with the internal supply line. Preferably, the adapter 16 is both internally and externally threaded 20. The adapter 16 can be threadedly connected to the housing 15, but is typically soldered to the housing 15 in order to secure the connection from any leaks. The adapter 16 can also be integral with the housing 15. The adapter 16 further includes a valve seat 17 (not shown) concentric to a fluid channel through the hydrant 10. Centrally positioned within the valve seat 17 is a valve port 18 (not shown) through which flow through the hydrant 10 is controlled, as will be explained below.

Running internally through the housing 15 from the faucet head 13 to the adapter seat 17 is a valve stem 21. Like the housing 15, this stem 21 can be of any material suitable for use in wall hydrant applications, and typically is copper. At the supply end 11 of the stem 21 is a valve nut or like element 22 for mating with the adapter valve seat 17. The stem 21 is positioned substantially centrally within the housing 15 and has an external diameter that is smaller than the internal diameter of the housing 15. The stem 21, and therefore the element 22, is positioned within the housing 15 so that it covers the adapter valve port 18 when seated on the adapter seat 17. In this manner, fluid flow through the hydrant 10 is prevented. The valve element 22 can include a valve gasket 23 for ensuring that the seal created by the element 22 seating on the seat 17 is complete and that no flow is permitted there through. The valve stem element 22 is able to freely rotate around the valve stem 21. Such design enables the element 22 to be stationary upon the adapter seat 17 as the stem 21 is extended by the rotation of the handle 25 against the element 22. The element 22 is secured around the end of the stem 22 by a screw or valve stem element connector 24 (not shown).

At the discharge end 12 of the hydrant 10, the stem 21 is connected to the handle 14 by a screw or stem handle connector 26. At least a portion of the handle stem 27 is threaded 28 for sealingly engaging with a handle-to-faucet connector 29. At least a portion of the connector 29 is externally threaded 30 for threadedly engaging with the faucet 13. The connector 29 further includes a nut portion 32 whereby one is able to screw the connector 29, and therefore the handle 14 and stem 21, into the faucet 13 and valve body 15. The connector 29 includes a gasket 31 for creating a seal when securedly engaged with the faucet 13. In this manner, both the faucet 13 and the connector 29 remain stationary while the handle 14 and valve stem 21 are rotated.

Rotation of the handle 14 in one direction moves the stem 21 and its element 22 towards the adapter seat 17 until the element 22 sealingly engages with the seat 17 over the port 18, thereby blocking flow through the valve 10. Rotation of the handle 14 in the other direction moves the stem 21 and its element 22 away from the adapter seat 17, thereby permitting flow through the valve 10.

Many times a hose or other accessory may be attached to the end of the faucet 13. This accessory may already contain fluid in it that has frozen, causing the outlet of the faucet to be blocked. Water within the valve body 15 is trapped. In freezing conditions, that water can freeze, thereby increasing in volume within the faucet valve body 15. As that volume increases, the pressure within the valve 10 increases to a point that can be in excess of that which is needed to rupture the valve body 15. Should such a rupture occur the subsequent leakage through the body 15 can be extremely damaging due to its camouflaged nature, as the leakage occurs within the confines of the wall space. Accordingly, there is a need for a valve having a means of reducing pressure therein during inclement conditions.

### SUMMARY OF THE INVENTION

The present invention disclosed herein alleviates the drawbacks described above with respect to responding to an increase in pressure in a valve, for example, when fluid within the chamber of the valve encounters freezing conditions and begins to freeze, thereby increasing pressure within the valve by increasing the volume within the valve. The valve pressure accumulator of the present invention is easily installed in presently available water hydrants. Under normal (i.e., non-freezing) operation, it displaces at least a portion of the fluid within the valve. When remaining fluid within the valve chamber freezes, it accumulates the expanding portion of the fluid within the housing of the valve.

In one embodiment, the valve pressure accumulator of the present invention includes a polymeric material disposed within the valve. The material is at least compressible, and preferably is deformably resilient such that it is able to deform as pressure within the valve increases beyond a normal limit and return at least partially to its original shape once that pressure is relieved. In one aspect, the pressure accumulator has one or more internally positioned grooves that allow the accumulator to deform or collapse when pressure within the valve increases above a certain value. This pressure accumulator can be positioned around a valve stem within the valve or inserted as a rod within the valve housing.

In another embodiment, the pressure accumulator of the present invention includes a polymeric material such as flexible foam disposed within the valve. In this embodiment, the material has ‘closed cells’ therein (i.e., air pockets) that enables the accumulator to deform as pressure within the valve increases beyond a normal limit. These closed cells enable the accumulator to compress or deform due to a pressure increase. Like the previous embodiment, this pressure accumulator can be positioned around a valve stem within the valve or positioned elsewhere within the housing. This embodiment of the pressure accumulator can also optionally have one or more internally positioned grooves that also assist or permit the accumulator to deform or collapse when pressure within the valve increases above a certain value; however, by proper selection of the polymeric material and the process used in forming the accumulator from the material, sufficient closed cells should be formed so that the grooves are not necessary.

In a third embodiment, the pressure accumulator includes an external pressure stem or tubing surrounding at least a portion of the length of a valve stem of the valve. This pressure stem is of a diameter that is greater than the valve stem but less than that of the valve housing. The space between the pressure stem and the valve stem can be filled with compressible material of sufficient density such that deformation does not occur until pressure within the housing body exceeds that of normal fluid pressure. As fluid within the valve begins to freeze, the compressible material begins to receive the additional volume created by the expansion of the fluid.

The present invention further provides a method of reducing an increase in pressure in the valve fluid chamber of a water hydrant. During normal operation, i.e., when fluid is flowing through the valve, pressure stays at or below a certain value based on the value of the fluid pressure from the internal supply line. When fluid contained within the valve body chamber encounters a freezing condition, the fluid begins to freeze and expand, increasing pressure within the valve body. In a situation where the amount of fluid within the valve body chamber is substantial, the freezing of the fluid can exert enough pressure to rupture the housing of the valve. With the pressure accumulator of the present invention, part of the volume of the fluid is displaced with the pressure accumulator. As the fluid freezes, the pressure accumulator contracts or compresses, thereby preventing the pressure from the freezing fluid to increase to a point that the integrity of the valve housing is threatened.

As designed, the valve pressure accumulator of the present invention is easily and conveniently installed in a wall hydrant. Its simple design allows it to be inexpensively manufactured. It may be manufactured in a wide range of sizes, based upon the size of the hydrant that it is placed in.

The valve pressure accumulator of the present invention is comprised of at least one component that enables it to overcome a threat to the rupture of the structure of the valve housing during a freezing condition. This component includes a device capable of reducing its own volume in response to an increase in pressure.

The general beneficial effects described above apply generally to each of the exemplary descriptions and characterizations of the devices and mechanisms disclosed herein. The specific structures through which these benefits are delivered will be described in detail herein below.

### BRIEF DESCRIPTION OF THE DRAWINGS

FIG. 1 is an exploded perspective view of a water hydrant found in the art showing the valve portion of hydrant.

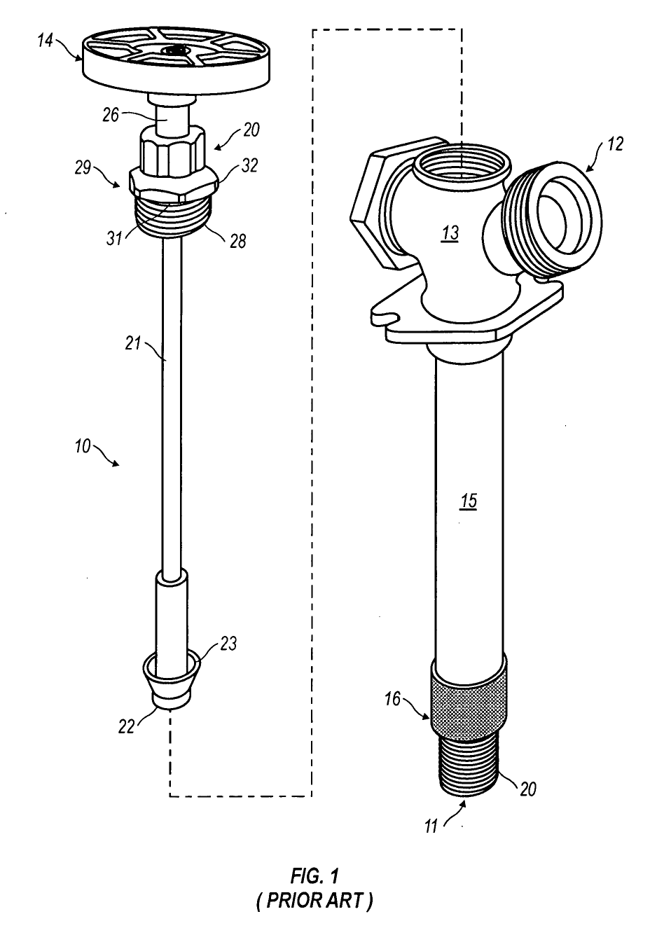

FIG. 2 is an exploded perspective view of a water hydrant found in the art with a cross-sectional view of one embodiment of a valve pressure accumulator according to the present invention showing the accumulator partially around the valve stem.

FIG. 3 is an exploded perspective view of a water hydrant found in the art with a cross-sectional view of another embodiment of a valve pressure accumulator according to the present invention showing the accumulator partially around the valve stem and surrounded by an external pressure stem.

FIG. 4 is an exploded perspective view of a water hydrant found in the art with a perspective view of even another embodiment of a valve pressure accumulator according to the present invention showing the accumulator around the valve stem.

FIG. 5 is an exploded perspective view of a water hydrant found in the art with a valve pressure accumulator similar to the embodiment illustrated in FIG. 2, but is able to be ‘snapped’ onto the valve stem.

### DETAILED DESCRIPTION OF THE INVENTION

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention. For example, although described as for use in a wall hydrant, it should be understood that the pressure accumulator may be used in other hardware if so desired.

Referring to the drawings, the pressure accumulator of the present invention is generally indicated at 33. The accumulator 33 is adjacent to the valve stem 21 and surrounds at least a portion of the length of the stem 21. The accumulator 33 is positioned between the stem 21 and the valve body 15. The external diameter of the accumulator 33 is smaller than that of the internal diameter of the housing 15 so that flow there through during normal operation is not impaired or stopped.

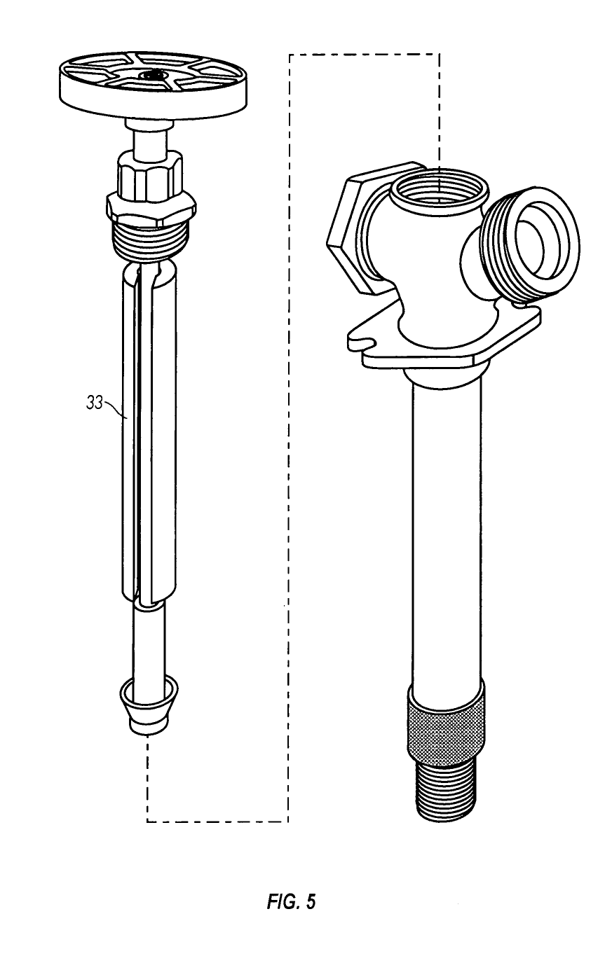

In other embodiments, the accumulator 33 can be in the shape of a tube that is slit lengthwise so that it can be easily installed or ‘snapped’ onto the valve stem 21. Such an embodiment is illustrated in FIG. 5. Further, the pressure accumulator 33 can be sized on its outside diameter so as to produce a frictional fit with the inside diameter of the valve housing 15.

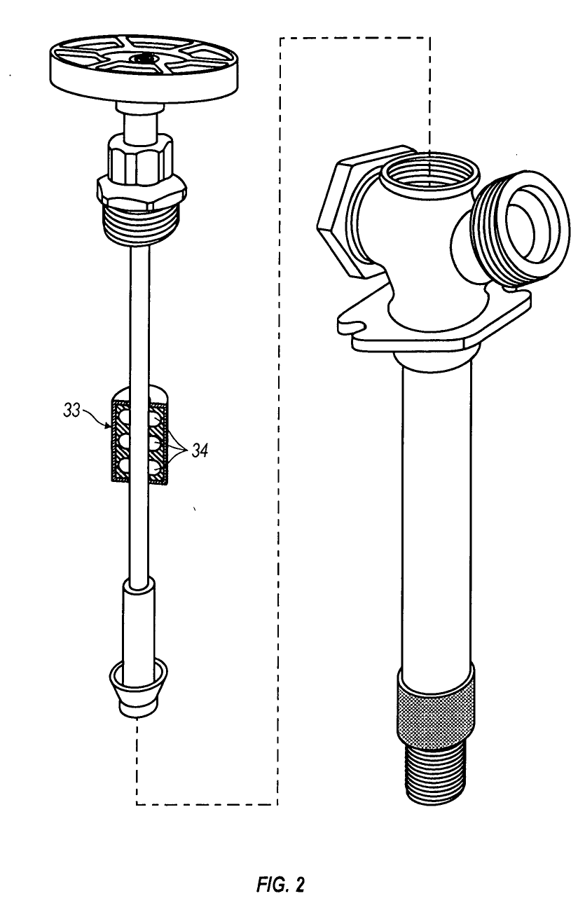

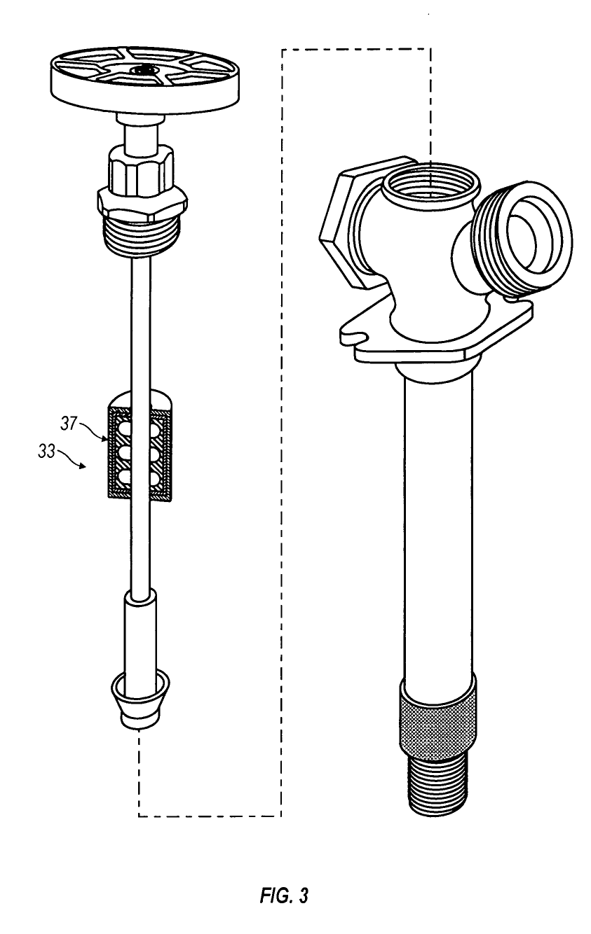

In the embodiment illustrated in FIGS. 2 and 3, the pressure accumulator 33 includes one or more internal grooves 34, effectively creating one or more air pockets between the accumulator 33 and the stem 21. Preferably, both ends 35, 36 of the accumulator 33 are sealed to the stem 21, for example by epoxy or other like means. As illustrated, the accumulator 33 can be made of rubber, foam or other flexible yet resilient polymeric material. The accumulator 33 can be a single polymeric component or multiples thereof. By having a nature that is both flexible and resilient, i.e., able to return to its original shape, the accumulator 33 occupies a portion of the space or volume in the interior of the body 15. During those times that fluid is retained within the body 15 and freezes, the accumulator 33 is able to flex and/or deform, thereby creating space within the chamber for the fluid to expand and reducing the pressure buildup within the body 15. By doing so, pressure within the valve 10 is prevented from obtaining a value that would rupture the body 15.

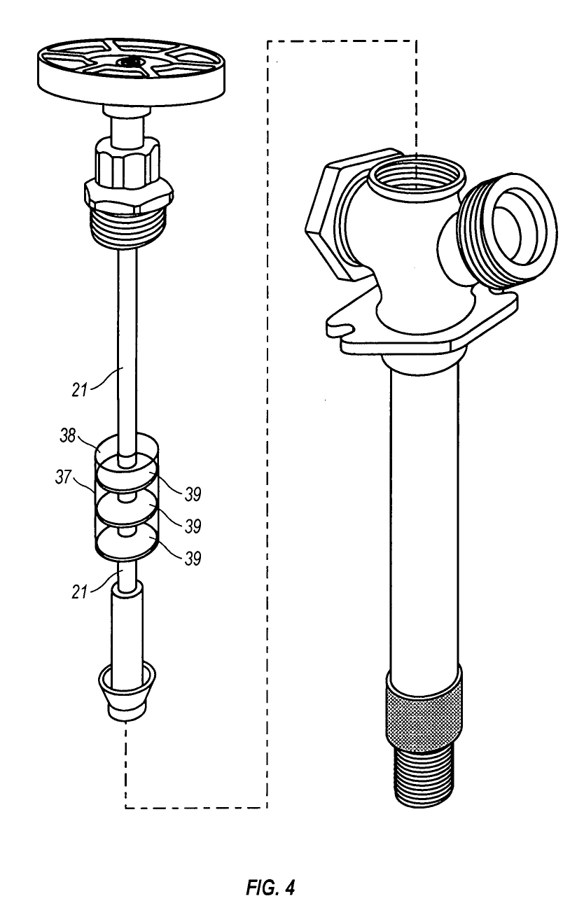

In another embodiment illustrated in FIG. 4, the accumulator 33 can include an external pressure stem 37 that is of a diameter greater than that of the valve stem 21 but smaller in diameter than the internal diameter of the valve body 15. Positioned between the pressure stem 37 and the valve stem 21 can be polymeric material of any of a multitude of designs. For example, the material can be of foam such as closed cell foam occupying the space between the pressure stem 37 and valve stem 21, a multitude of flexible beads, polymeric material as described above with one or more grooves 34 disposed therein, and so forth. The grooves 34 can also be reverse, i.e., creating air pockets between the pressure stem 37 and the polymeric material. The combination of the external pressure stem 37 and polymeric material function in a manner similar to that described above for the embodiment wherein the accumulator 33 is comprised of the polymeric material.

In one embodiment, the accumulator 33 is formed from material that includes ‘closed cells’ within the material. By ‘closed cell’ it is meant that the material has gas pockets therein. These gas pockets can be formed, for example, by the addition of a suitable foaming agent during an injection or extrusion process of the material, or manually created such as by drilling holes within the material and then sealing the holes thereby creating gas pockets. One skilled in the art would recognize that certain materials could be created with gas pockets during an extrusion process while other materials, e.g., natural rubber or un-foamed material, would not contain such gas pockets. These closed cell accumulators 33 can then compress during a pressure increase due to their gas pockets. Further, one skilled in the art would recognize that such material can be processed, e.g., by extrusion, to any shape desired. In this respect, FIG. 5 illustrates an embodiment of such a shape to be formed for use according to the present invention. The accumulator 33 of FIG. 5 can be so processed to result in a product with or without the optional grooves 34 illustrated in FIGS. 2 and 3.

In addition to the presence of closed gas cells produced during the manufacture of suitable accumulator foam, the structural characteristics of the cell walls should be capable of withstanding an elevated pressure. For example, a suitable foaming agent such as an azodicarbonamide (commercially available as UNICELL™ D-1500 from Dongjin Semichem Co., Ltd., Seoul, Korea), used to foam Santoprene™ 203-50, produces cell walls that do not exhibit substantial deformation until subjected to pressures exceeding 250 psi. If the compression begins below 250 psi, which is the rated working pressure of a typical valve body, compression capacity of the accumulator is wasted by possible pre-existing working water pressure in the valve. Although the gas in the cells is compressed when the accumulator is subjected to pressure, it is believed that the cell walls provide most of the resistance to compression.

Depending upon the particular embodiment utilized, the accumulator 33 can be formed from a variety of material that is both flexible and resilient. Examples of suitable material include rubber such as natural rubber, nitrile rubber, butyl rubber, neoprene ((polychloroprene) rubber), latex and high-end EPDM rubber compounds; thermoplastic elastomers (‘TPE’) such as the Santoprene™ line of TPEs commercially available from Advanced Elastomer Systems (an ExxonMobil affiliate, Akron, Ohio); thermoplastic vulcanizate (TPE with a chemically crosslinked rubbery phase); thermoplastic olefins and their blends; plasticized polyvinyl chloride; polyurethanes and so forth.

In one embodiment the accumulator 33 can be formed from material that is at least partially compressible. In this respect, one skilled in the art would recognize that certain material would not be suited for this purpose, such as unfoamed natural rubber. An example of a material suitable for use includes foamed thermoplastic elastomers (‘TPE’) such as the Santoprene™ line of TPEs mentioned above.

### EXAMPLES

Procedural: A variety of materials were tested for their suitability for use in an accumulator according to the present invention. Those materials were as follows—

cork

foamed urethane

nitrile

epdm

silicone

natural rubber

thermoplastic elastomers, including Santoprene™ TPEs

From the above materials a c-shaped tube or cylinder of each foamed material was prepared such as is illustrated in FIG. 5. Each cylinder had an internal diameter slightly larger than a standard valve stem.

Procedural

Closed Cell Test—

Various materials were tested to determine their suitability for use as a pressure accumulator. Material was tested to determine whether it was closed-cell and capable of retaining its closed-cell properties at working pressures it could be subject to. A ten (10) inch length of the material piece in the shape of a tube or c-shaped device is weighed and the weight noted. A typical weight for the accumulator was about 30 grams. The test sample is then put into a pressure chamber and pressurized with water to 1000 psi, which is above the pressure normally encountered in valves with the properly sized accumulator installed (e.g., such as in a freezing condition). For reference, the pressure typically encountered in a stressed state without an accumulator is about 6000 psi, which is the limit due to the rupture of the valve body. Most housing codes require that a valve housing endure 250 psi. After 2 minutes the sample is removed and weighed. Any weight gain can be attributed to water that has been absorbed by the device. An increase in weight of more than 5%, or about 1.5 grams, was considered as unacceptable in that it possibly would not protect a valve adequately in actual service.

Floating Density Test—

Density, or the percentage of foam closed cells formed during manufacture, was also evaluated to determine the suitability of material for use in forming the accumulator. A ten (10) inch sample is floated vertically in a water bath with one end submerged and the other end in the air. Considering the density of the base material (here, foamed Santoprene) to have a density of one, the portion of the test sample that is above the water surface indicates the percentage of gas in the closed cells of the sample. Typically, about 3.5 inches of sample is above the water surface and 6.5 inches is below. This would indicate a density of 0.65 compared to water, and a cell volume of 35%, which is acceptable for use in the formation of an accumulator.

Material Resilience Test—

Polymeric material resilience or rebound after it is subjected to pressure was also evaluated for suitability for use in an accumulator. Once the density of the test sample is known, the same sample is put into the pressure chamber as in the closed cell test and subjected to 1000 psi for two minutes. The sample is then removed from the chamber and allowed to recover for ten (10) minutes at atmospheric pressure. The floating density test is then repeated. Any increase of density above the first result, for example, the 0.65 density now measuring 0.7, indicates that the cells have compressed or deformed and have not recovered. Typically, all materials tested take a small amount of set and density increase the first time they are subjected to pressure, for example, 5% to 10%. However, a material deemed suitable does not exhibit substantial increased set on subsequent retests. Also, any material that does not reliably and repeatably recover to a density of 0.7 or less has limited use as an accumulator material.

Accumulator Volume—

The amount of material installed in a valve is determined. Considering a valve having an internal volume of 40 ml, freezing that amount of water would produce approximately 44 ml of ice. Accumulators installed in a valve preferably displace approximately 20 ml (approximately half) of that volume. The remaining 20 ml of water would then only form 22 ml of ice when frozen. The 20 ml volume of the accumulator having a density of 0.7 or less would contain 30%, or 6 ml of compressible gas. This would provide a safety factor of 3 (6 ml compressible gas/2 ml ice growth) before damaging pressure would start to develop within the valve. A wide range of densities and specified safety factors may be used to eliminate damaging internal pressures.

Although use of un-foamed rubber for an accumulator as mentioned in prior art provides some deformation, it is not a preferred material due to its non-compressible nature, i.e., it does not have closed cells and therefore contains no gas to compress.

Although the present invention has been described and illustrated in detail, it is to be clearly understood that the same is by way of illustration and example only, and is not to be taken as a limitation. The spirit and scope of the present invention are to be limited only by the terms of any claims presented hereafter.

### INDUSTRIAL APPLICABILITY

The present invention finds applicability in the valve industry, and more specifically in adaptive fittings or pressure accumulators for valves. Of particular importance is the invention's ability to enable the upgrade and/or retrofit of current water hydrant valves without damaging the wall or hydrant during installation.

What is claimed is:

1. A pressure accumulator for displacing pressure within a valve comprising:
a polymeric material disposed within the valve that is able to contract as pressure within the valve increases beyond a normal limit.

2. The pressure accumulator of claim 1 wherein the polymeric material is disposed around a valve stem of the valve.

3. The pressure accumulator of claim 1 wherein the polymeric material is at least partially compressible.

4. The pressure accumulator of claim 1 wherein the polymeric material comprises one or more thermoplastic elastomers.

5. The pressure accumulator of claim 1 further comprising an external pressure stem surrounding at least a portion of the length of a valve stem of the valve.

6. The pressure accumulator of claim 1 wherein the accumulator is disposed along at least a portion of a valve stem of the valve.

7. The pressure accumulator of claim 5 further comprising a polymeric material able to contract as pressure is increased within a valve body of the valve.

8. The pressure accumulator of claim 7 wherein the pressure stem and the polymeric material are the same.

9. The pressure accumulator of claim 5 wherein the polymeric material is disposed between the pressure stem and the valve stem.

10. The pressure accumulator of claim 1 wherein the polymeric material is flexible foam.

11. The pressure accumulator of claim 1, wherein the accumulator is in the shape of a tube and is slit lengthwise for installation on a valve stem.

12. The pressure accumulator of claim 1, wherein the accumulator is sized on its outside diameter so as to produce a frictional fit with the inside diameter of a valve housing.

13. The pressure accumulator of claim 1 further comprising one or more internal grooves.
